(19) United States
(12) Patent Application Publication
(10) Pub. No.: US 2011/0252187 A1
(43) Pub. Date: Oct. 13, 2011

(54) SYSTEM AND METHOD FOR OPERATING A NON-VOLATILE MEMORY INCLUDING A PORTION OPERATING AS A SINGLE-LEVEL CELL MEMORY AND A PORTION OPERATING AS A MULTI-LEVEL CELL MEMORY

(76) Inventors: Avigdor SEGAL, Netanya (IL); Igal Maly, Tel Aviv (IL); Boris Barsky, Kfar Saba (IL); Ilan Bar, Kiryat Motzkin (IL)

(21) Appl. No.: 13/070,245

(22) Filed: Mar. 23, 2011

Related U.S. Application Data
(60) Provisional application No. 61/321,743, filed on Apr. 7, 2010.

(51) Int. Cl. G06F 12/02

(52) U.S. Cl. 711/103; 711/E12.008

(57) ABSTRACT

System and method for storing data in a non-volatile memory including a multi-level cell and single-level cell memory portions. To write a dataset to the non-volatile memory, if the size of the dataset is equal to the size of pages in the multi-level cell memory portion, the dataset may be written directly to the multi-level cell memory portion to fill an integer number of pages in a single write operation. However, if the size of the dataset is different than the size of the multi-level cell memory pages, at least a portion of the dataset may be temporarily written to the single-level cell memory portion until data is accumulated in a plurality of write operations having a size equal the size of the multi-level cell memory pages. The accumulated data may fill an integer number of the pages in the multi-level cell memory portion in a single write operation.

### CROSS-REFERENCE TO RELATED APPLICATIONS

This application claims the benefit of U.S. Provisional Patent Application No. 61/321,743, filed Apr. 7, 2010, which is incorporated herein by reference in its entirety.

### FIELD OF THE INVENTION

Embodiments of the present invention relate to systems and methods for storing data in non volatile memories, such as, single and multi level cells of a flash memory unit.

### BACKGROUND OF THE INVENTION

Flash memories may be single-level cell (SLC) memories or multi-level cell (MLC) memories. SLC memories may store a single bit of information in each memory cell and MLC memories may store multiple bits of information in each memory cell. Since MLC memories store more bits in each cell, MLC memories typically have higher density memory storage, resulting in cheaper manufacturing costs than SLC memories. Lower manufacturing costs make MLC memories more commonly used in most standard consumer memory devices.

However, the electrical properties of the MLC memories may degrade at a faster rate as compared with SLC memories, resulting in a shorter lifespan for the MLC memories.

### SUMMARY OF EMBODIMENTS OF THE INVENTION

Embodiments of the present invention provide systems and methods for using a non-volatile memory having a part operating as a multi level cell memory for long-term storage and a part operating as a single cell memory for temporary storage to collect and combine partial write operations at the single level cell memory part to decrease the total number of write operations to the multi level cell memory part.

Embodiments of the present invention provide systems and methods for using a non-volatile memory having a portion operating as a multi-level cell memory storing data in pages and a portion operating as a single-level cell memory electrically connected to the multi-level cell memory portion. An instruction may be received to write a dataset to the non-volatile memory. If the size of the dataset is equal to the size of an integer number of the pages, the dataset may be written directly to the multi-level cell memory portion to fill an integer number of the pages in the multi-level cell memory portion in a single write operation. However, if the size of the dataset is different than the size of an integer number of the pages, at least a portion of the dataset may be written temporarily to the single-level cell memory portion until data is accumulated in a plurality of write operations to the single-level cell memory portion having a size equal the size of an integer number of the pages. The accumulated data may be written from the single-level cell memory portion to fill an integer number of the pages in the multi-level cell memory portion in a single write operation.

Embodiments of the present invention provide systems and methods for storing data using a multi-level cell (MLC) memory, a plurality of single-level cell (SLC) cache blocks electrically connected to the MLC memory, and a plurality of ports electrically connected to the plurality of SLC cache blocks. A plurality of streams of data may be written via the ports to each partially fill two or more pages of the SLC cache blocks. The data from the plurality of streams of data may be merged to completely fill one or more merged pages of the SLC cache blocks. Each of the merged pages of the SLC cache blocks may be written to completely fill a page in the MLC memory in a single operation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system including a non-volatile memory having a multi-level cell (MLC) memory portion and a single level cell (SLC) memory portion according to an embodiment of the invention;

FIG. 2 schematically illustrates a system including a non-volatile memory with a portion operating as an MLC memory and a portion operating as an SLC memory according to an embodiment of the invention; and

FIG. 3 is a flowchart of a method for operating SLC and MLC memory portions of a non-volatile memory according to an embodiment of the invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Each cell of a single-level cell (SLC) memory or multi-level cell (MLC) memory may correspond to a slot or physical location with one or more floating-gate transistors. Data may be written to flash memories by injecting electrons between electrically isolated floating-gates cells, where the electrons may be trapped or fixed by the insulating properties of the floating-gates. Data may be erased by removing electrons from the cells of the insulating layer.

To read the memory, a voltage may be applied to each cell and the resulting current may be measured to detect the electrons in the cell. For each single-level cell storing a single bit of information, the single bit may be read by simply measuring the presence or absence of current to define the two states of a binary field for the single data bit (e.g., (0) or (1)). For each multi-level cell storing more than one (e.g., N) bits of information, the amount of current flow may be measured (rather than simply the presence or absence of current for single-level cells), in order to determine more precisely the level of charge in the cell to define the (e.g., 2^{N}) binary states for the multiple (e.g., N) bits in each cell.

A flash memory may degrade over its lifetime, for example, averaging several years. Writing (injecting electrons) and erasing (deleting electrons) may degrade the properties of the floating-gates that trap the electrons in the corresponding cell slots. As the number of write and erase operations accumulate over the lifetime of a flash memory which may result in an increase in memory errors.

Each memory has a limited or maximum number of programmable (e.g., write and/or erase) operations in its lifespan before the memory degrades beyond an acceptable degree, for example, producing an error rate that exceeds limits set by system standards. The maximum number of programmable operations may be referred to as the “endurance” of the memory. The endurance of a memory may vary depending on the (e.g., silicon) manufacturing process, the number of bits stored per cell and the memory usage (e.g., cycling rate, retention, temperature, etc.). An SLC memory (storing one bit per cell) typically has a greater endurance (e.g., a maximum number of 10⁴-10⁶ programmable operations) than a MLC memory (e.g., having a maximum number of 10³ programmable operations). For example, during their lifetimes, a single-level cell memory may have approximately ten times greater endurance than a MLC memory storing two bits per cell and approximately a hundred times greater endurance than a MLC memory storing three bits per cell.

According to an embodiment of the invention, a combination of both SLC and MLC memory structures may be used to exploit the benefits of each type of memory structure. The MLC memory may be used for its higher storage density and cheaper cost, while SLC memory may be used for its greater endurance. Some of MLC memory blocks may be temporary or permanently used as SLC blocks, e.g., accessing only a single cell level in those blocks. In one embodiment, one or more SLC memory blocks may act as gatekeepers to provide intermediate storage to an MLC memory. The SLC memory blocks (e.g., having relatively higher memory endurance) may accumulate and combine programmable operations before they are transferred to MLC memory blocks to reduce the number of programmable operations executed at the MLC memory blocks (e.g., having relatively lower memory endurance) to slow the degradation and increase the lifespan of the MLC memory.

In one embodiment, an MLC memory may store data in blocks or pages of a predetermined size. A processor may write a set of data to the MLC memory. If the written data is exactly the size of the storage page (or whole number of pages that may be written together) in the MLC memory, exactly one write operation may be used to store the data. However, if the written data is a different size than the size of the storage pages, a conventional processor may only partially fill a storage page, for example, with written data that is smaller than the size of the page or whole number of pages or with the remainder of written data that does not fit into a storage pages if the written data is larger than the size of the page (or whole number of pages). In conventional systems, writing data to memory that only partially fills a storage page may either waste the remaining unused storage page or use additional write and erase operations to completely fill the storage page and erase additional data blocks, thereby wasting the limited number of write operations to the memory and shortening the memory lifespan.

According to embodiments of the invention, SLC memory blocks (e.g., having a significantly greater number of available write operations) may accumulate all the partial write operations to the MLC memory until one or more complete storage page(s) are filled to generate a single full storage write operation to the page(s) of the MLC memory (e.g., having a significantly smaller number of available write operations). By condensing multiple data block write operations at the SLC memory blocks to a single full data block write operation to the MLC memory, embodiments of the invention may shift the task of combining multiple write operations to the SLC memory (having greater endurance) to save the more limited write operation resources of the MLC memory (having lower endurance) to extend the life of the MLC memory.

In a negated AND (NAND) flash memory systems, each time data is written to a new storage location, the contents of the data block may be erased using an erase operation to prepare the block for storage. In conventional systems, data may be stored without aligning the data with storage pages. If the data is not aligning with the storage pages, the data may only partially fill some storage pages generating empty portions in the pages. These empty portions may waste storage space causing the processor to prematurely move on to the next storage block. Since the processor may use an erase operation to clear each storage block that is used, prematurely using an extra storage block may cause the processor to prematurely use extra erase operation thereby wasting the limited number of programmable erase operations available to the MLC memory.

In contrast, according to embodiments of the invention, an SLC memory may align the received data with storage pages in the SLC and/or MLC memories. In some embodiments, the SLC memory may store the beginning of a received data stream at the beginning of a storage page or a remaining portion of the storage page if the storage page is partially filled. By aligning the received data with storage pages, the SLC memory may fill each page completely to avoid empty potions of pages. Aligning received data and storage blocks at the SLC memory may further reduce the number of pages and therefore blocks used to store received data by avoiding empty gaps in the pages. This smaller number of storage blocks and pages may then be written to the MLC memory. Accordingly, a smaller number of erase operations may be used to clear blocks in preparation for storage in the MLC memory. Decreasing the number of erase operations at the MLC memory may further extend the life of the MLC memory.

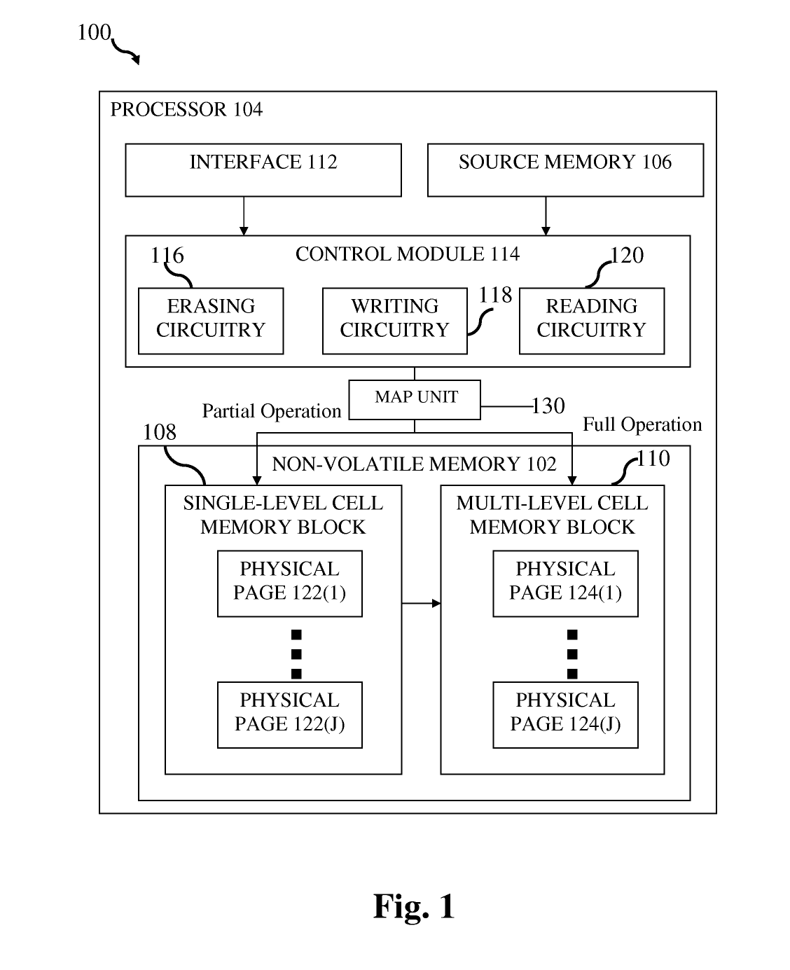

Reference is made to FIG. 1, which schematically illustrates a system 100 including a non-volatile memory 102 having a single-level cell (SLC) memory portion and a multi-level cell (MLC) memory portion according to an embodiment of the invention.

System 100 may include a computer device capable of executing a series of instructions to write, read, modify, erase, store, save, process, encode, decode, compute, edit, receive, transfer, display, or otherwise use or manipulate data. System 100 may include one or more computers, workstations, cellular device, tablet devices, personal digital assistants (PDA), video game consoles, etc. In one embodiment, system 100 may be a computer with a flash memory, secure digital (SD) card or disk drive.

System 100 may include a processor 104 to receive one or more instruction(s), for example, via a program interface 112 to read, write, and/or erase data from a source memory 106 to non-volatile memory 102. Processor 104 may include a control module 114 having erasing circuitry 116, writing circuitry 118 and reading circuitry 120, for erasing, writing and reading data to non-volatile memory 102, for example, as defined by the receive instruction(s). Circuitry 116, 118, 120 may include one or more dedicated hardware units, or processor 104 executing software.

Non-volatile memory 102 may include one or more external drives such as a disk or tape drive, a universal system bus (USB) drive, a solid-state drive, a memory card such as a SD card, a network card, an input/output device port or a memory in an internal or external device. Non-volatile memory 102 may include a flash memory, such as, NOR-type flash memory, negated AND (NAND)-type flash memory, and phase-change random access memory (PRAM).

Source memory 106 may be a separate from or integral to non-volatile memory 102. An integral source memory 106 may be used to move data within non-volatile memory 102 or as an intermediate temporary storage, for example, used to buffer or queue data written to non-volatile memory 102. Source memory 106 may be a non-volatile or volatile memory. A volatile memory may include buffer memory, cache memory, random access memory (RAM), dynamic RAM (DRAM), scratchpad memory, or other suitable memory units or storage units for direct use by a processor 104. Volatile memory may be used for short-term storage, while non-volatile memory may be used for long-term memory storage.

Non-volatile memory 102 may include one or more single-level cell (SLC) memory blocks 108 and one or more multi-level cell (MLC) memory blocks 110. Each cell may store one bit of information (in SLC memory blocks 108) or a plurality of (e.g., N) bits of information (in MLC memory blocks 110), for example, in floating-gate transistors. For SLC memory blocks 108, each cell may include (to an acceptable level of certainty) two statistically distinguishable regions or physical levels, for example, one corresponding to a zero value and one other region corresponding to a non-zero value, defining two states (e.g., 0 and 1) for a single bit. For MLC memory blocks 110, each cell may include (to an acceptable level of certainty) more than two statistically distinguishable regions or physical levels, for example, one corresponding to a zero value and at least two or more other regions corresponding to different non-zero values, defining (e.g., 2^{N}) binary states for the multiple (e.g., N) bits in each cell. The number (e.g., N) of bits of information in cells of MLC memory blocks 110 may be greater than one and may or may not be an integer number.

SLC memory blocks 108 may have a higher endurance, for example, reprogrammable by approximately (e.g., 10^{N-1}) times more program (e.g., write/erase) cycles, than MLC memory blocks 110 (e.g., with (N) bits of information per cells) before irrecoverable storage errors occur. To reduce the number of reprogrammable operations and extend the lifetime of MLC memory blocks 110, processor 104 may only execute complete programmable operations (e.g., writing one or more complete page(s) 124 or erasing one or more block(s)) at MLC memory blocks 110. Processor 104 may execute the remaining partial write operations (e.g., writing less than a page 124 or erasing less than a block of data) at SLC memory blocks 108. SLC memory blocks 108 may merge the partial write operations into full write operations, which are then transferred to MLC memory blocks 110. Accordingly, the burden of executing partial write operations may be transferred to SLC memory blocks 108 having a relatively high endurance to support such operations and the partial write operations may be condensed to a fewer number of full write operations executed at MLC memory blocks 110 having a relatively lower endurance.

SLC memory blocks 108 and/or MLC memory blocks 110 may store data in one or more (physical) pages 122, 124 (1)-(J), respectively. Each page 122 and/or 124 may include a portion of data representing original information and a portion of data representing error correction data, such as, redundancy and/or back pointers for the original information for correcting errors that may have occurred during a page read operation. A plurality of cells of non-volatile memory 102 may be processed together as a page 122, 124 and a plurality of pages may be processed together as a block 108, 110, such as an erase block which is erased in preparation for writing. In some embodiments, cells of non-volatile memory 102 may be erased, for example, block by block, but may be written into and/or read from non-volatile memory 102, for example, page by page. Alternatively, only the MLC memory portion of non-volatile memory 102 may have a data structure including pages 124 and blocks 108. For example, the SLC portion of non-volatile memory 102 may have a different data structure, for example, linear streams of data or multi-dimensional arrays of data. Regardless of the data structures used, a predefined unit and/or predefined dimensions of data in SLC memory 108 (e.g., a data stream segment or block of fixed size) may correspond to each unit of data used in a complete programmable operation in MLC memory blocks 110 (e.g., a full page 124 for a complete write operation and/or a full erase block 110 for a complete erase operation). Other groupings or partitions of data or memory cells may be used.

In one embodiment, processor 104 may receive a write instruction from interface 112 to write data addressed to MLC memory blocks 110. The data may be provided in a corresponding data stream, for example, from source memory 106 or another memory. The data in the data stream may have a size equal to or different than the storage size of an integer number of pages 124 in MLC memory blocks 110. If the data stream has a data size equal to an integer number of pages 124, the data may completely fill each page 124 and the operation to write the data to MLC memory blocks 110 may be referred to as a full write operation. However, if the data stream has a data size different than an integer number of pages 124, the data may have a remaining dataset that only partially fills a page 124 and the operation to write the data to MLC memory blocks 110 may be referred to as a partial write operation.

Processor 104 may use a mapping unit 130 to map partial write operations (e.g., filling only a portion of at least one page 124) to SLC memory blocks 108 and full write operations (e.g., filling one or more complete page(s) 124) to MLC memory blocks 110.

Mapping unit 130 or control module 114 may determine the size or dimensions of the instruction data to determine if the operation occupies a complete storage unit (e.g., page 124 or block 110) for a complete programming operation at MLC memory blocks 110. In some cases, when the instruction data is larger than, but not the size of a complete storage unit of MLC memory blocks 110, mapping unit 130 may split the data into one or more full data groups and a partial data group (e.g., the left-over or remainder of the data that does not completely fill a storage unit). Mapping unit 130 may map the partial split portion of the data to SLC memory blocks 108 and the complete split portion(s) of the data to MLC memory blocks 110. Mapping unit 130 may include one or more dedicated hardware units, or processor 104 executing software. Mapping unit 130 may be integral to or separate from processor and/or control module 114.

Other partitions of data, storage structures, and system circuitry may be used.

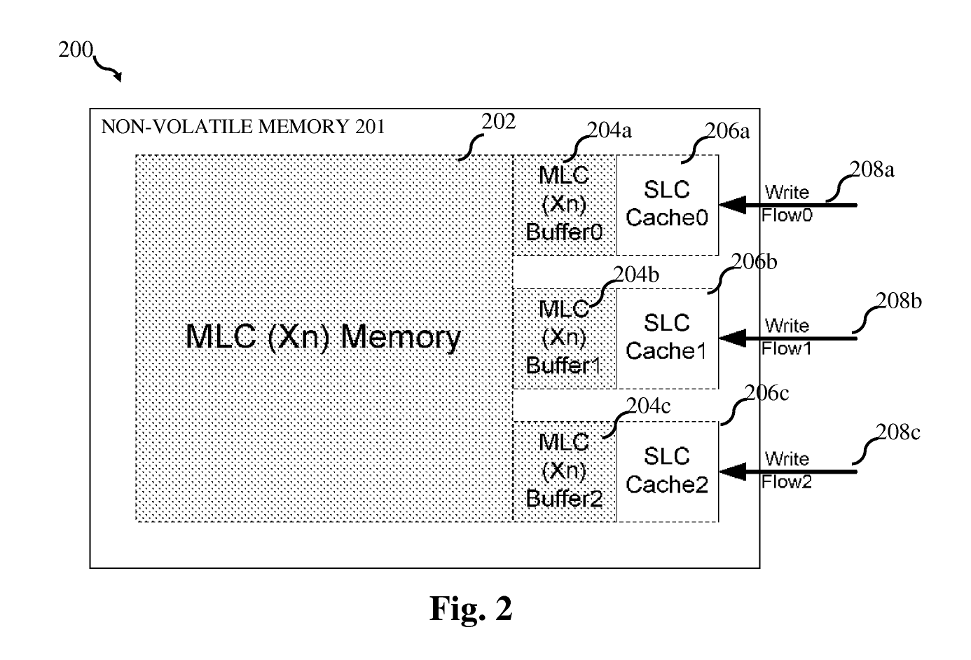

In some embodiments, non-volatile memory 102 may have a native MLC memory structure, a portion of which may be temporarily used or converted to an SLC memory structure to intercept partial write operation in the data stream to MLC memory blocks 110. In yet other embodiments, non-volatile memory 102 may have a combined or integrated SLC and MLC memory structure. In one example where non-volatile memory 102 has a native MLC memory structure, all data may ultimately be written to MLC memory blocks 110 and a subset of the data, for example, data in partial write operations, may temporarily be written to SLC memory blocks 108. In some embodiments, non-volatile memory 102 may include volatile memory components, for example, MLC buffers, SLC caches (e.g., as described in reference to FIG. 2), etc., to merge partial write operations and queue the data to MLC memory blocks 110. However, non-volatile memory 102 may ultimately store the data in a non-volatile memory structure, such as, MLC memory blocks 110.

Reference is made to FIG. 2, which schematically illustrates a system 200 including a non-volatile memory 201 with a portion operating as an MLC memory 202 coupled to a portion operating as an SLC memory 206 according to an embodiment of the invention.

A processor (e.g., processor 104 of FIG. 1) or a mapping unit (e.g., mapping unit 130 of FIG. 1) may write one or more data streams 208a-c to non-volatile memory 201 (e.g., non-volatile memory 102 of FIG. 1). Each of data streams 208a-c may be addressed, for example, to a sequential page (e.g., page 124 of FIG. 1) of MLC memory portion 202 in non-volatile memory 201. In one example for a write operation to an SD card, data streams 208a-c may include a file allocation table (FAT) and a directory (DIR) to address the data as well as the data itself. To write data to a page of MLC memory portion 202, a Read-Modify-Write operation may be used, which may include the steps of, for example:

(a) Read the previously stored data from the data block;

(b) Modify the read content with the new content of data streams 208;

(c) Erase the data block; and

(d) Write the new content to the data block.

MLC memory portion 202 may have a plurality of (Xn) bits per cell (e.g, two, three, four bits per cell). MLC memory portion 202 may include one or more buffers 204a-c each having one or more buffer blocks, for example, to temporarily store data from data stream 208a-c prior to writing the data to MLC memory portion 202. A buffer block may be assigned to each successive address or erase block of MLC memory portion 202. Each data stream 208a-c may be programmed to an empty buffer block out of a list or pool of empty buffer blocks. Each buffer block may be mapped to a physical block in MLC memory portion 202, for example, at the address space defined in the data stream 208a-c. Each buffer block in buffers 204a-c may be the same size as each memory block of MLC memory portion 202 (if all blocks in MLC memory portion 202 are the same size) or the same size as a corresponding memory block of MLC memory portion 202 (if two or more blocks in MLC memory portion 202 have different sizes).

In one example, a data stream 208a may be written to MLC memory portion 202 to a destination physical address of the next sequential available memory block {i} in MLC memory portion 202. An empty buffer block {t} in a buffer 208a may be allocated from a list of available buffer blocks and data from data stream 208a may be written into buffer block {t}. Once the data is written to buffer block {t}, buffer block {t} and memory block {i} may be merged together and the contents of buffer block {t} may be written to memory block {i}. MLC memory portion 202 may acknowledge a successful write to memory block {i} (e.g., by signaling a host via interface 112 of FIG. 1). Buffer block {t} may be merged into memory block {i} by a sequence of steps including, for example:

(1) Read buffer block {i};

(2) Modify the read content with the content of buffer block {t};

(3) Erase memory block {i}; and

(4) Write the modified content of buffer block {t} to memory block {i}. Buffer block {t} may then be erased and returned to the available buffer list.

However, in some cases, when the new content of data stream 208a has a different size than the size of one or more page(s) of MLC memory portion 202, the data written to MLC memory portion 202 in each write operation may only partially fill at least one memory page. Writing data to part of a memory page may be time consuming and may waste MLC memory portion 202 resources.

Accordingly, embodiments of the invention use a portion of non-volatile memory 201 as an SLC memory 206 coupled to MLC memory portion 202 and/or buffers 204a-c to reduce the number of partial write operations to and extend the life of MLC memory portion 202. Data streams 208a-c may first pass to SLC memory portion 206 (e.g., via one or more input ports) where partial write operations are extracted and any remaining full write operations are passed to buffers 204a-c and/or MLC memory portion 202; otherwise data streams 208a-c may be split before reaching SLC memory portion 206 such that only partial write operations are delivered to SLC memory portion 206 and only full write operations are delivered to buffers 204a-c and/or MLC memory portion 202.

A plurality of partial write operations may be written to SLC memory portion 206 until data equal to the size of a complete memory page(s) of MLC memory portion 202 is accumulated. SLC memory portion 206 may transfer the accumulated data in a single write operation to an intermediate buffer 204a-c and/or directly to MLC memory portion 202 to completely fill a next available page of buffer 204a-c and/or memory block of MLC memory portion 202. Accordingly, data streams 208a-c may first be written to a plurality of data (e.g, cache) blocks in SLC memory portion 206 and then to a fewer number data blocks of buffers 204a-c and/or MLC memory portion 202 blocks using a fewer number of programming operation (read-modify-write) cycles at MLC memory portion 202.

In the example shown in FIG. 2, a cache block in SLC memory portion 206 is assigned to each buffer 204a-c block in MLC memory portion 202. In other examples, a single cache block in SLC memory portion 206a may be assigned to more than one buffer 204a-c block or more than one cache blocks in SLC memory 206a-c may be assigned to a single buffer 204a block in MLC memory portion 202. Accordingly, the number of assigned cache blocks in SLC memory 206a-c may be higher than, equal to, or less than the number of assigned buffer 204a-c blocks in MLC memory portion 202.

The write operations of one or more data streams 208a-c may be split into two types of write operations:

(a) If the data size of the data stream 208a-c is equal to the size of a page or larger than the size of the page, the stream equal to the size of a page or the portion of the larger stream equal to the size of a page is written directly to a page of buffer 204a-c.
(b) If the data size of the data stream 208a-c is smaller than the size of a page or larger than the size of the page, the stream smaller than the size of a page or the remaining portion of the larger stream smaller than the size of a page (e.g., the portion not written in (a)) is written to an empty page of a cache block of SLC memory portion 206. Once write operations accumulate data up to the size of the MLC page in the cache block of SLC memory portion 206, the cache block is merged into the buffer block of buffer 204a-c of MLC memory portion 202. The blocks may be merged in a controller or processor memory. When the buffer block is full, the memory block in MLC memory portion 202 may be erased, and the buffer block may be written over the memory block. If the buffer block is not full, it may be merged with the memory block by a sequence of read; modify; and write operations.

In some embodiments, the data stored in multiple write operations to partially fill pages in SLC memory portion 206 may be stored in fewer write operations to completely fill a fewer number of pages in MLC memory portion 202. Accordingly, the number of program write and erase operations to MLC memory portion 202 may be reduced to extend the lifetime of MLC memory portion 202.

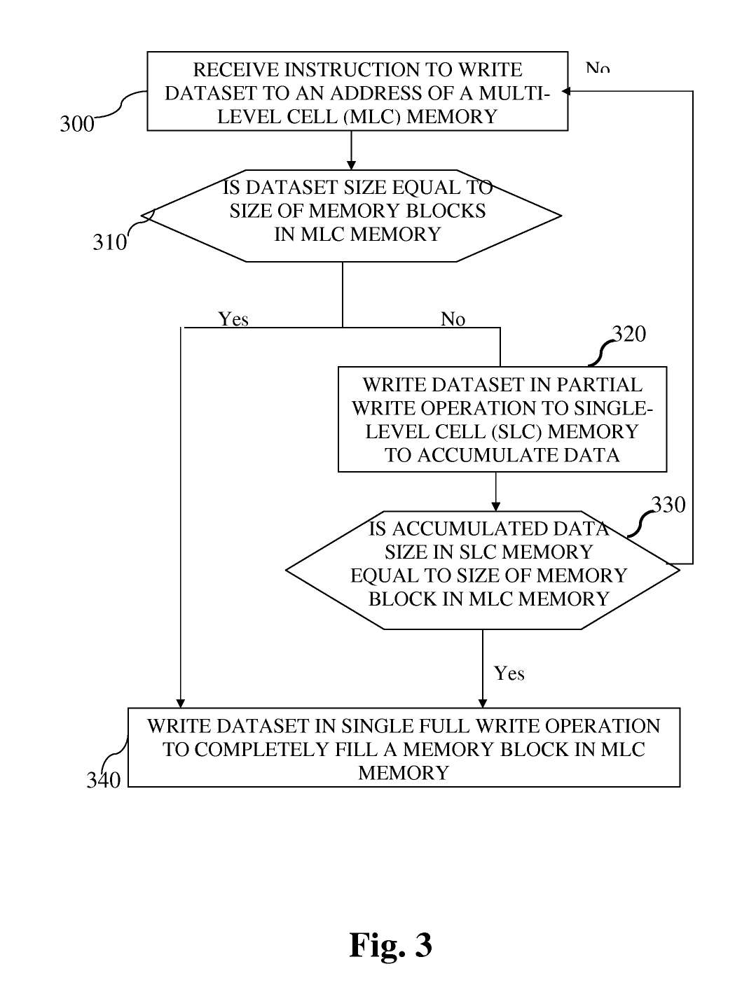

Reference is made to FIG. 3, which is a flowchart of a method for operating SLC and MLC memory portions of a non-volatile memory according to an embodiment of the invention.

In operation 300, a processor (e.g., processor 104 of FIG. 1) may receive an instruction (e.g., from interface 112 of FIG. 1) to write a dataset from a source memory (e.g., source memory 106 of FIG. 1) to an address of an MLC portion of a non-volatile memory (e.g., MLC memory blocks 110 of FIG. 1). The processor may write data to the multi-level cell memory portion in pages, for example, of a predetermined size. The address may be a specific memory address, an address to store the dataset at a location relative (e.g., sequentially) to other datasets or an address indicating the next available memory location in the MLC or non-volatile memory.

In operation 310, the processor may determine if the size of the dataset is different than or equal to (e.g., exactly or approximately equal to or within a predetermined threshold of) the size of an integer number of pages. If the size of the dataset is equal to the size of an integer number of pages, a process or processor may proceed to operation 340. If the size of the dataset is different than the size of an integer number of pages, a process or processor may proceed to operation 320.

In operation 320, the processor may write at least a portion of the dataset, for example, that is smaller than one of the data blocks, temporarily, to a portion of the non-volatile memory operating as single-level cell memory.

In operation 330, the processor may determine if the size of the data accumulated, for example, in a plurality of partial write operations 320 to the single-level cell memory portion, is equal to the size of an integer number of pages. If the size of the accumulated data in the single-level cell memory portion is equal to the size of an integer number of pages in the multi-level cell memory portion, a process or processor may proceed to operation 340. If the size of the accumulated data is smaller than the size of an integer number of pages in the multi-level cell memory portion, a process or processor may proceed to operation 300 to receive a new instruction to write a new dataset.

In operation 340, the processor may write the single dataset or a plurality of accumulated datasets equal to the size of an integer number of data blocks directly into the multi-level cell memory portion in a single write operation. The data may completely fill the integer number of pages. The single dataset may be written directly from the source memory and the plurality of accumulated datasets may be written from temporary storage at the intermediate single-level cell memory portion. In some embodiments, the multi-level cell memory portion may be coupled to one or more buffers, each assigned to buffer data before writing the data to an available data block. In some embodiments, data written directly to the multi-level cell memory portion may include data written directly to the buffers coupled thereto.

Other operations or orders of operations may be used.

It may be appreciated that an MLC memory may refer to any memory with more than one bit per cell, for example, two bits per cell, three bits per cell (e.g., also referred to as a triple-level cell (TLC) memory), four bits per cell, or any integer or rational number greater than one of bits per cell.

It may be appreciated that although an SLC memory (with one bit per cell) is described as an intermediate memory to handle partial write-erase operations to an MLC memory (with two or more bits per cell), a memory with any lesser number of levels (N) per cell may be used as an intermediate memory to handle partial write-erase operations to a memory with any greater number of levels (≧N+1 levels) per cell. For example, an SLC with one bit per cell may be used to merge partial write-erase operations to MLC with two bits per cell, an MLC with two bits per cell or an SLC with one bit per cell may be used to merge partial write-erase operations to an MLC with three bits per cell (e.g., a TLC), an MLC with two or three bits per cell or an SLC with one bit per cell may be used to merge partial write-erase operations to an MLC with four bits per cell, and so on.

It may be appreciated that, before they are merged in an MLC memory, an SLC memory may accumulate and combine data written or erased in a plurality of partial write or erase operations until a storage block is completely (e.g., 100%) filled or approximately (e.g., ≧90%) filled, or above a predetermined threshold (e.g., ≧Q %) filled. Furthermore, it may be appreciated that a storage block, data block or page may refer to any predetermined or standardized partition of cells operated on together in a complete program (e.g., write/read/erase) operation, e.g., one or more data blocks, one or more pages, a plurality of cells, etc. It may be appreciated that different groupings of cells may be used for different programmable operations where, for example, each erase operation may erase a complete block of non-volatile memory (e.g., each block including multiple pages) and read or write operation may read from or write into a complete page of non-volatile memory. It may be appreciated that data block, pages, or any partition of cells may differ between memory units and/or within the same memory unit.

It may be appreciated that although non-volatile memory (e.g., non-volatile memory 102 of FIG. 1) may include volatile memory components, for example, MLC buffers, SLC caches, etc., to merge partial write operations and queue the data, the data may ultimately be stored in a non-volatile memory structure.

Embodiments of the invention may be software-implemented using dedicated instruction(s) (e.g., retrieved via interface 112 or stored in a memory 102,106 of FIG. 1) or, alternatively, hardware-implemented using designated circuitry (e.g., circuitry 116, 118, 120 of FIG. 1) and/or logic arrays.

Embodiments of the invention may include an article such as a computer or processor readable medium, or a computer or processor storage medium, such as for example a memory, a disk drive, or a USB flash memory, for encoding, including or storing instructions which when executed by a processor or controller (for example, processor 104 of FIG. 1), carry out methods disclosed herein.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

What is claimed is:

1. A device comprising:
a non-volatile memory including a portion operating as a multi-level cell memory storing data in pages and a portion operating as
a single-level cell memory electrically connected to the multi-level cell memory portion; and
a processor to receive an instruction to write a dataset to the non-volatile memory, wherein if the size of the dataset is equal to the size of an integer number of the pages, the processor writes the dataset directly to the multi-level cell memory portion to fill an integer number of the pages in the multi-level cell memory portion in a single write operation and wherein if the size of the dataset is different than the size of an integer number of the pages, the processor writes at least a portion of the dataset temporarily to the single-level cell memory portion until data is accumulated in a plurality of write operations to the single-level cell memory portion having a size equal the size of an integer number of the pages and the processor writes the accumulated data from the single-level cell memory portion to fill an integer number of the pages in the multi-level cell memory portion in a single write operation.

2. The device of claim 1, wherein if the size of the dataset is smaller than the size of one of the pages, the processor writes the entire dataset to the single-level cell memory portion.

3. The device of claim 1, wherein if the size of the dataset is larger than the size of the page, the processor writes a portion of the dataset equal to the size of one or more pages directly to the multi-level cell memory portion and a remaining portion of the dataset smaller than the size of the page to the single-level cell memory portion.

4. The device of claim 1, wherein the single-level cell memory portion stores data in pages the same size as the pages of the multi-level cell memory portion.

5. The device of claim 4, wherein when a plurality of partial write operations, each partially filling a page in the single-level cell memory portion, together completely fill the page in the single-level cell memory portion, the processor writes the entire page in a single write operation from the single-level cell memory portion to a page in the multi-level cell memory portion.

6. The device of claim 1, wherein the pages have a predetermined size.

7. The device of claim 1, comprising a plurality of single-level cell memory blocks each independently storing data in the multi-level cell memory portion.

8. The device of claim 7, comprising a plurality of multi-level cell buffer blocks each independently storing data directly in the multi-level cell memory portion.

9. The device of claim 8, comprising an equal number of single-level cell memory blocks and multi-level cell buffer blocks, wherein each single-level cell memory block is independently connected to a unique multi-level cell buffer block.

10. The device of claim 1, wherein the single-level cell memory portion is a cache memory.

11. The device of claim 1, wherein the non-volatile memory is a flash memory unit.

12. A method comprising:
receiving an instruction to write a dataset to a non-volatile memory including a portion operating as a multi-level cell memory and a portion operating as a single-level cell memory, wherein data is written to the multi-level cell memory in pages;
if the size of the dataset is equal to the size of an integer number of the pages, writing the dataset directly to the multi-level cell memory portion to fill an integer number of pages in the multi-level cell memory portion in a single write operation;
if the size of the dataset is different than the size of an integer number of the pages, writing at least a portion of the dataset temporarily to the single-level cell memory portion until data is accumulated in a plurality of write operations to the single-level cell memory portion having a size equal the size of an integer number of the pages; and
writing the accumulated data from the single-level cell memory portion to fill an integer number of the pages in the multi-level cell memory portion in a single write operation.

13. The method of claim 12, wherein if the size of the dataset is smaller than the size of one of the pages, the entire dataset is written to the single-level cell memory portion.

14. The method of claim 12, wherein if the size of the dataset is larger than the size of one of the pages, a portion of the dataset equal to the size of one or more pages is written directly to the multi-level cell memory portion and a remaining portion of the dataset smaller than the size of one page is written to the single-level cell memory portion.

15. The method of claim 12, wherein data is written to the single-level cell memory portion in pages the same size as the pages of the multi-level cell memory portion.

16. The method of claim 15, wherein when a plurality of partial write operations, each partially filling a page in the single-level cell memory portion, together completely fill the page in the single-level cell memory portion, the entire page is written in a single write operation from the single-level cell memory portion to a page in the multi-level cell memory portion.

17. The method of claim 12, wherein the pages in the multi-level cell memory portion have a predetermined size.

18. The method of claim 12, wherein data written from the single-level cell memory portion to the multi-level cell memory portion are aligned with the pages of the multi-level cell memory portion.

19. A system for storing data, comprising:
a multi-level cell (MLC) memory;
a plurality of single-level cell (SLC) cache blocks electrically connected to the MLC memory;
a plurality of ports electrically connected to the plurality of SLC cache blocks; and
a processor to write a plurality of streams of data via the ports to each partially fill two or more pages of the SLC cache blocks, to merge the data from the plurality of streams of data to completely fill one or more merged pages of the SLC cache blocks and to write each of the merged pages of the SLC cache blocks to completely fill a page in the MLC memory in a single operation.

20. The system of claim 19, wherein the data stored in two or more write operations to partially fill the two or more pages of the SLC cache blocks are stored in fewer write operations to completely fill a fewer number of pages in the MLC memory.
